(19) United States
(12) Patent Application Publication
(10) Pub. No.: US 2012/0179387 A1
(43) Pub. Date: Jul. 12, 2012

(54) Method for Urodynamics Testing and Analysing

(76) Inventors: Huinan Deng, Guangzhou (CN); Hu Chen, Jiangmen (CN); Bo Song, Chongqing (CN); Yi Chen, Jiangmen (CN)

(21) Appl. No.: 13/496,841

(22) PCT Filed: Sep. 13, 2010
(86) PCT No.: PCT/CN10/76835

§ 371 Date: Mar. 16, 2012

(30) Foreign Application Priority Data
Sep. 16, 2009 (CN) 200910190862.4

(51) Int. Cl. G06F 19/00

(52) U.S. Cl. 702/19

(57) ABSTRACT

A method for urodynamics testing and analysing comprises the steps of building an elastic element model of urethral bladder; building an urethral model; keeping anterior urethra perpendicular to the direction of gravity, measuring and recording urination data and calculating urination parameters; calculating the contraction length of the elastic element, further calculating the contraction velocity and contraction acceleration of the elastic element, and assessing the contraction function of detrusor muscle by using the maximum contraction acceleration of the elastic element; and learning the measurement of urethral resistance by using the cross-section area of the urethral model, and finding out the state of urethral obstruction by using the maximum cross-section area.

### FIELD OF THE INVENTION

The present invention relates to a medical detection method, especially to a method for urodynamics testing and analysing.

### BACKGROUND OF THE INVENTION

Urodynamics is a branch of interdisciplinary knowledge of modern medicine, biofluid mechanics and biorheology which is usually used for the basic research, diagnosis, treatment and assessment of urinary tract obstructions, incontinence, urinary tract dysfunction and the other diseases, and is closely related with urinary surgery, department of gynaecology and obstetrics, department of pediatrics, division of endocrinology, neurology, anorectal.

At present, the parameters measured directly for regular urodynamics are pressure inside of urinary bladder and rectum, urinary flow rate and urine volume. The most commonly used method is invasive urodynamics testing method comprising: inserting piezometer tube into urinary bladder for measuring both pressure inside and urinary flow rate; dragging constant current perfusion piezometric tube at constant speed for measuring the pressure distribution of each section of urinary tract; performing analysis and diagnosis of diseases by using AG,PG diagrams. The testing result can be assured mostly to match real condition with using the method, but the testing is performed in non-physiological state and it is possible to get false positive results, furthermore, the invasive testing increases the possibility of suffering and infection for patient.

Some scholars performed the study from the viewpoint of energy except mechanical analysis, for example such as energy consumption equation for urination F=9.79×10²P−1.25×10⁻³Q²+9.8H. The energy consumption equation for urination derived from the infinitesimal flow rate equation for Bernolli viscous liquid takes bladder outlet and external urethral orifice as research plane, flow velocity is that urinary flow rate is divided by cross section area of external urethral orifice(standard cross section area of external urethral orifice). As known to us, the Bernoulli's Equation reflects the transforming relationship between mechanical energy and the other type of energy (mainly heat energy for energy loss), the application condition is: i. steady flow incompressible fluid, no shape changing for differential stream tube over time; ii. mass force is just gravity, no input or output for grossflow except head loss between two wetted cross-sections; iii. the two wetted cross-sections taken must be slow variable flow cross section but rapidly varied flow between two wetted cross-sections; iv. no change for grossflow flow rate along channel. As known from Hill's principle, voiding pressure is different with different volume of urinary bladder, that is to say, there is energy input and vary over time; urinary tract defines the boundary for urine releasing movement, the urinary tract shape varies over time during urination, the movement of urinary flow is unsteady, urodynamics is related to the coupling of fluid motion and boundary distortional motion, it is possible to use the momentum equation reflecting the relationship between liquid fluid and boundary action. Therefore it does not reflect the real condition if the infinitesimal flow rate equation for Bernolli viscous liquid is used for the research of lower urinary tract urodynamics without considering other influencing factors.

The published literatures discloses the drop spectrometer based on the optics theory, modulated light is focused on testing diode through horizontal gap, the light disappeared is related to the shade of drop going through light curtains. Urinary stream can be seen to be composed by drops through high-speed camera, time and volume of each drop can be determined by testing changes in pulse. Obstruction can be tested by using the technology but the obstruction closed to urinary bladder. The published literatures also discloses the invention which tests changes of light by using CCD.

U.S. Pat. No. 5,377,101 discloses a method for analyzing urinary flow rate curve by computer which is to perform diagnosis through comparing urinary flow rate curve tested with standard curve. T₉₀—voiding time for the central 90% of the voided volume. The calculation of this variable is carried out in the curve; when the points on the time axis that correspond with 5% and 95%. Q_{M90}—flow rate during the central 90% of voided volume. T_{desc}—time of descending leg. The time elapsed from the moment of maximum flow to the moment 95% of voided volume has been recorded. D_{1/dt40}—estimated bladder wall contraction velocity at 40 ml bladder contents. The method can not fully describe the related to the number, complicated and non-linear fluid system, the resistance factors includes sphincter, prostate gland and distal urethral, furthermore, urinary bladder and urethra are both creep. The method still can not assess detrusor muscle weakness, prostatic hyperplasia and urethral stricture owing to pressure and urinary flow rate both are non-linear.

In prior art, a testing method for sleeve-shaped catheter and apparatus thereof based on piezometer tube principle of fluid mechanics is disclosed, that is, the sleeve-shaped catheter is mounted to penis and close outlet with clamping device to make the pressure inside of catheter go up, the urine filled in urethra can not be testing catheter to measure the pressure inside of urine bladder until the urine flow stops motion. The possibility of infection still exists even though the testing catheter does not need to be inserted. The whole process of urine flow can not be observed with the method, and the material of the sleeve-shaped catheter is difficult to keep consistence, and the repeatability of testing result is poor.

U.S. Pat. Nos. 5,807,278 and 5,823,972 disclose a noninvasive bladder pressure and urinary flow measurement apparatus and method. The method comprising the steps of: placing an inflatable cuff about the penis of the child male; placing a pressure transducer in fluid communication with the urine in the urethra; inflating said inflatable cuff to cause said inflatable cuff to prevent flow of urine through the urethra in the penis; deflating said inflatable cuff thereby allowing urine to flow freely under said force. Inflating said inflatable cuff causes suffering of penis, and the result is influenced by the position, size, shape and material of the inflatable cuff which is not easy to be standardization.

The published literatures disclose a urine flow velocity inside of urethra can be estimated by Doppler, which is found to match invasive testing method well based on the study of a small group of cases, for example such as prostate gland obstruction and the junction part (calculated by velocity and flow rate), the rate of prostate gland and peritoneum. The processes are complicated due to the testing result is achieved inside of glass tube in which the flow rate is bigger than 2 ml/s.

The published literatures discloses that sound is produced by the turbulent flow while urine passes by prostate gland, and recorded in the perineal to assess obstruction. In the obstruction model built with a penis sheath, the different sound occurred based on different obstruction. The testing environment requirement of the method is critical, and the data is complicated for handling, and it does impact the testing result that the probe placed in the perineal presses cavernous body of urethra.

The published literatures discloses that male obstruction can be checked by measuring weight and thickness of urinary bladder. The outlet obstruction can be checked by measuring the thickness of detrusor muscle with B-ultrasound at the urinary bladder volume of 250 ml. But the cases of extensive trabecular, diverticularization, urinary bladder wall incrassation, bladder atony can not be checked by the method.

The published literatures discloses a testing method with near infrared spectroscopy, the method comprises placing probe on patient phalanx to detect the change of detrusor muscle hemoglobin by infrared, and finding out the change of urinary bladder pressure. The apparatus costs high and the clinic effect is to be determined.

### SUMMARY OF THE INVENTION

The present invention provides a method for urodynamics testing and analysing by means of which to measure the speed and mass of the urine flowing out of external urethral orifice, and analyze contraction function of urinary bladder and urethral resistance by using fluid momentum equation and law of energy conservation based on the elastic element model of urethral bladder and urethral model built in accordance with topology theory, in order to eliminate the deficiencies, for example such as pain and/or infection for patient caused by invasive testing method, inaccuracy and/or high cost for non-invasive testing method, while taking the methods of prior art. The method is used for evaluation of tests and efficacy of surgery and/or pharmaceuticals for the patient who has lower urinary tract symptom.

The technical proposal according to the present invention for the technical problems is a method for urodynamics testing and analysing comprises of the steps of:

Step 1: building an elastic element model of urethral bladder to regard the urine inside of urinary bladder before its releasing as a topological sphere, regarding the action of urinary bladder detrusor muscle and abdominal pressure as the action of the elastic element, the elastic modulus thereof is able to vary over time and with space changing, and according to the elastic element model defining L=F(a) which shows the function relation between the length of elastic element L and the urine volume of urinary bladder a, and ΔL=ξ(Q,a) which shows the function relation between contraction length ΔL and urinary flow rate Q, urine volume of urinary bladder a;

Step 2: building a urethral model regarding urethra as horizontally-placed tube, and the length and cross section area thereof vary quickly over time, varying of momentum and energy of the urine in the urethral model reflects action of urethra on urine;

Step 3: keeping anterior urethra perpendicular to the direction of gravity to measure and recording the urination data comprising an original position of urine releasing, a urine releasing height h, a mass of releasing urine mi over time ti, a horizontal displacement di, and calculating urination parameters comprising a urinary flow rate Q over time ti, a urine flow velocity vu-i, a kinetic energy of releasing urine per unit time Ei and a cross-sectional area Si of the urethral model;

Step 4: calculating a contraction length of the elastic element ΔLi according to ΔL=ξ(Q,a) which shows a function relation between contraction length ΔL and urinary flow rate Q, urine volume of urinary bladder a, and further calculating the contraction velocity and contraction acceleration of the elastic element vi and ad-i so as to assess the contraction performance of detrusor muscle by using the maximum contraction acceleration of the elastic element ad-max;

Step 5: learning the condition of urethral resistance by using the cross section area of the urethral model Si, and finding out the state of urethral obstruction by using the maximum cross section area Smax.

The present invention has the advantages of eliminating the pain of a sufferer and the possibility of infection caused by a conventional invasive urodynamics testing method; an overall analysis process can be performed automatically with the aid of a computer; the results thereof are clear and convenient for clinical memory and use; the device used for the method has the characteristics of simple structure and convenient maintenance; and therefore, the medical cost is reduced, with performing the assessment of the urethral obstruction and the contraction performance of detrusor muscle of patient through external testing and mathematics analyzing.

### BRIEF DESCRIPTION OF THE DRAWINGS

The accompanying drawings facilitate an understanding of the various embodiments of this invention. In such drawings:

FIG. 1 is a diagram of urinary flow rate of a male patient having bladder outlet obstruction;

FIG. 2 is a diagram of the contraction acceleration of detrusor muscle of a male patient having bladder outlet obstruction;

FIG. 3 is a histogram of the maximum contraction acceleration and frequency of a male patient having urethral obstruction with detrusor muscle being in normal state;

FIG. 4 is a flow chart of the method for analyzing the maximum kinetic energy—contraction length according to the present invention;

FIG. 5 is a flow chart of the method for analyzing the contraction acceleration of detrusor muscle and the cross section area of urethra according to the present invention.

### DETAILED DESCRIPTION OF ILLUSTRATED EMBODIMENTS

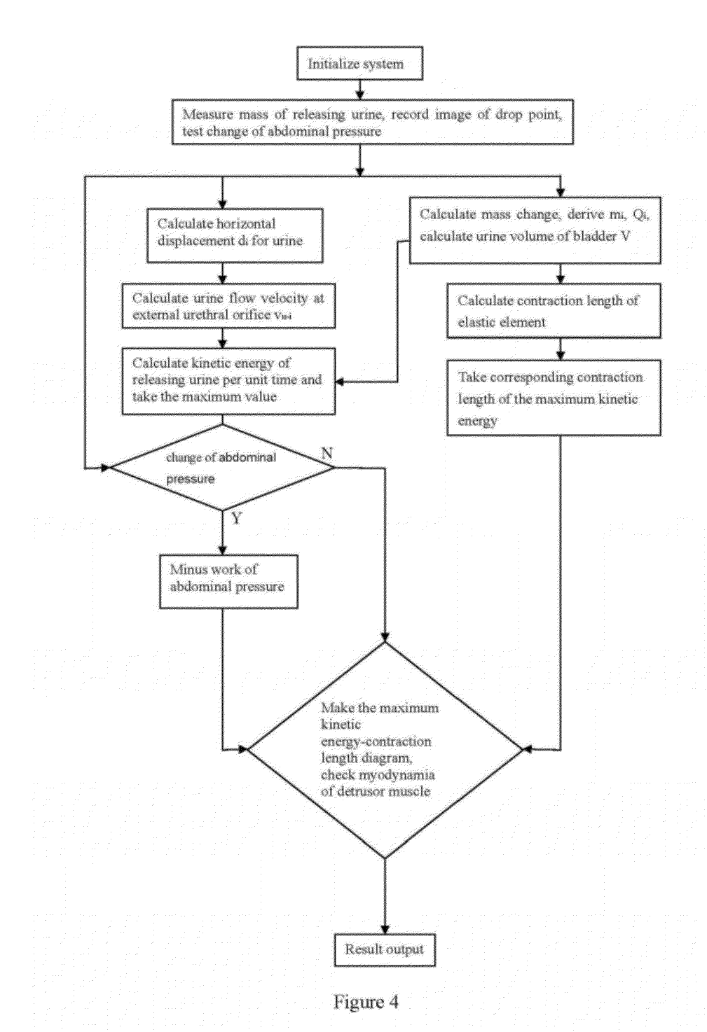

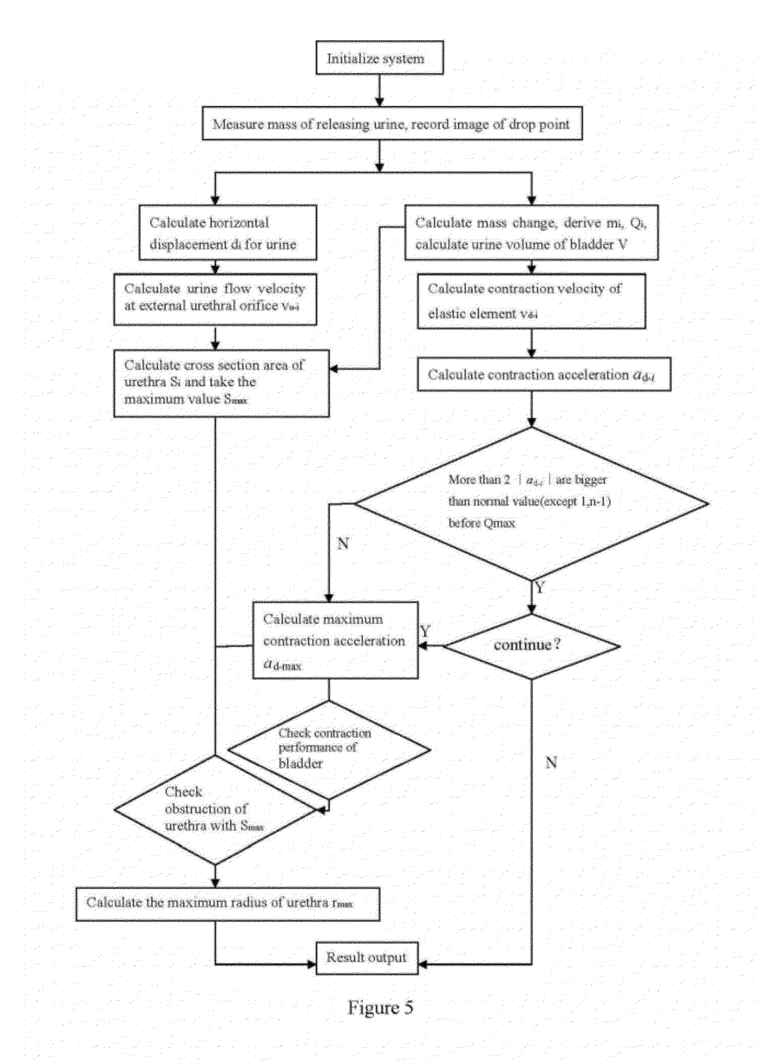

A method for urodynamics testing and analysing comprises the following steps with referring to FIGS. 4 and 5 according to the present invention:

Step 01: building an elastic element model of urethral bladder to study detrusor muscle, the research of biorheology states that detrusor muscle of urinary bladder is of the ability to be fasciculation, it is impossible to decompose tensile force into active force and passive force, the modulus of elastic element model of detrusor muscle is the function of the fiber length as well as the function of time at a predetermined length, and the detrusor muscle may be loose completely without stress. No single state exists in resting state, thus Hill model is not suitable for the study. Video-urodynamics shows that urinary bladder with proper urine volume is sphere shape during urine releasing, and the urine inside of urinary bladder before releasing can be regarded as topological sphere, the action of detrusor muscle of urinary bladder and abdominal pressure can be regarded as the action of the elastic element, the elastic modulus thereof is able to vary over time and with space changing, and according to the elastic element model defining L=F(a) which shows the function relation between the length of elastic element L and the urine volume of urinary bladder a, and ΔL=ξ(Q,a) which shows the function relation between contraction length ΔL and urinary flow rate Q, urine volume of urinary bladder a, generally the volume of the sphere is equal to the urine volume a of urinary bladder, the original length Li of the elastic element is equal to the perimeter of the sphere contour which is equivalent to the length of the detrusor muscle fiber around the urinary bladder, the vary of the sphere volume is the urinary flow rate Q, based on that described above the function relation between the length of elastic element L and the urine volume of urinary bladder a can be defined according to topology function, which is L=F(a)=2*(π²*a)^{1/3}≈8.36084644*a^{1/3}, and the function relation between contraction length ΔL and urinary flow rate Q, urine volume of urinary bladder a is ΔL=ξ(Q,a)=Q/{[a^{1/3}+(a−Q)^{1/3}]²−a^{1/3}*(a−Q)^{1/3}}.

Step 02: building an urethral model which regarding urethra as horizontally-placed tube, and the length and cross section area thereof vary quickly over time, varying of the momentum and energy of the urine in the urethral model reflects the action of urethra on urine, the research of biorheology states that urethra is characterized by elastic hysteresis, stress relaxation, creep and Boltzmann superposition, the cross section area of urethral lacunae vary at different sections, and non-linear change of the urethral lacunae takes place with changes of time and kinetic energy of urinary flow, which appears as resistance non-linear change over time, the resistance is just a value on condition that the time is infinitesimal, thus, it is possible to build a horizontal tube model which produces the same resistance in order to derive a calculating method for cross section area of urethral model Si, which is that urinary flow rate is divided by urine flow velocity, that is Sᵢ=Qi/vu-i, according to law of energy conservation.

Step 03: keeping anterior urethra perpendicular to the direction of gravity to

measure and recording the urination data comprising an original position of urine releasing, an urine releasing height h, a mass of releasing urine mi over time ti, a horizontal displacement di, and calculating urination parameters comprising an urinary flow rate Q over time ti, an urine flow velocity vu-i, a kinetic energy of releasing urine per unit time Ei and a cross-section area Si of the urethral model, wherein the urinary flow rate Qi at a certain point in time can be derived by calculating (mi−mi−1)/(ti−ti−1), the calculation formula for urine flow velocity vu-i is vu-i=di/t, wherein the value of t has direct correlation with the height of urine releasing, t=(2h/g)^{1/2}, kinetic energy of releasing urine per unit time is Ei=(mi−mi−1)(vu-i)²*0.5, cross-section area of the urethral model is Si=Qi/vu-i, the present invention further provides method to record and calculate the other parameters and data other than the urination parameters and urination data described above, for example such as total urination time, total urinary flow time, average flow rate, residual urine volume (can be measured after releasing urine by using B-ultrasound), average urine flow velocity, maximum contraction velocity and contraction time of urinary bladder, total output power, average output power, maximum output power and time, maximum power acceleration, total momentum, total kinetic energy etc. furthermore, it is possible to further make urinary flow rate curve, urine flow velocity curve, contraction velocity curve of elastic element, output power curve, momentum curve, cross section area of the urethra curve etc. based on all data and parameters described above, a subsequent analysis and study can be performed with comparing with normal curves.

Step 04: calculating a contraction length of the elastic element ΔLi according to ΔL=ξ(Q,a) which shows a function relation between contraction length ΔL and urinary flow rate Q, urine volume of urinary bladder a, and further calculating the contraction velocity and contraction acceleration of the elastic element vi and ad-i so as to assess the contraction performance of detrusor muscle by using the maximum contraction acceleration of the elastic element ad-max, wherein the contraction velocity vi=(ΔLi−ΔLi−1)/(ti−ti−1),the contraction acceleration ad-i=(vi−vi−1)/(ti−ti−1), the method for calculating the maximum contraction acceleration of the elastic element ad-max is to make time-contraction velocity diagram to take the time period from starting releasing urine to achieving the maximum urine flow velocity, the maximum urinary flow rate and the maximum cross section area of the urethra, calculate the slope of contraction velocity by using regression analysis method and to take the slope as the maximum contraction acceleration ad-max. A method for assessing contraction performance of detrusor muscle comprises comparing the maximum contraction acceleration with a normal value of that for the same age group, the contraction performance of detrusor muscle is good if the value of maximum contraction acceleration is within normal range; the contraction performance of detrusor muscle is possible to be impaired and need to do further inspection if the value is less than normal value.

Step 05: learning the condition of urethral resistance by using the cross section area of the urethral model Si, and finding out the state of urethral obstruction by using the maximum cross-section area Smax. The average value of the maximum value of 2-3 cross-sections area in a row can be taken as the maximum cross-section area Smax, and a method for finding out the state of urethral obstruction comprises the steps of:

I. comparing the maximum cross section area with a normal value of that for a same age group, and issuing a judgment that no urethral obstruction exists if the maximum cross-section area value is within normal range, and calculating the maximum radius of urethra to turn to step V; and issuing a judgment that a urethral obstruction exists if the value is less than a normal value and turn to step II;

II. making curve for time-cross section area of the urethra, and issuing a judgment that a detrusor-sphincter dyssynergia or other interference factors exist if the curve has a big wave amplitude;

III. reviewing the curve for time-cross section area of the urethra to see if horizontal long straight section exists, and issuing a judgment that it is constrictive obstruction if it exists, and issuing a judgment that it is compression obstruction if it does not exist;

IV. calculating a maximum theoretical urethral radius;

V. outputting the calculated result.

It is possible to use different methods to measure the horizontal displacement di for the measurement described above, one of the preferred methods comprises:

I. recording the image data of drop point for releasing urine;

II. comparing each frame image recorded with a previous frame image, and ignoring the frame image if it has a same placement image as that of the previous frame image;

III. recording the timepoint of the frame image if it is different from the previous frame image, and performing a binary imaging for it by using the threshold method of a maximum equation difference, and calculating its drop point after boundary searching;

IV. calculating a horizontal displacement di between the original point and the drop point of urine releasing according to the system marks of the concentric circle which has an original point of micturition as its center point.

The present invention further provides preferred steps following the step 05 in order to perform the better analysis for contraction performance of urinary bladder and urethra resistance according to the data recorded.

Step 06: taking the maximum value of kinetic energy of releasing urine output per unit time Eimax to check if any change of abdominal pressure occurred: said maximum value of kinetic energy can be a maximum kinetic energy if no any change occurred; the value that the maximum value of kinetic energy minus the work of abdominal pressure can be a maximum kinetic energy if any change occurred. A method for checking abdominal pressure comprises: comparing the absolute value of contraction acceleration ad-i with the normal value and issuing a judgment that the change of abdominal pressure exists if more than two absolute value are bigger than normal value during the period of time other than start time T0 and end time T_{END}, wherein T₀ and T_{END} are around 1 S, and which occurs before the maximum urinary flow rate value Qmax out of Qi exists, with removing artificial interference and/or instrument artifact.

Step 07: making diagram of maximum kinetic energy-contraction length according to the maximum kinetic energy and the corresponding contraction length ΔLi, and finding out the rate for myodynamia of detrusor muscle and obstruction.

Due to the change of abdominal pressure impacts the analysis result a lot, during practical application, the data without changing abdominal pressure is preferred to be taken for analysis and calculation in order to avoid inaccurate result.

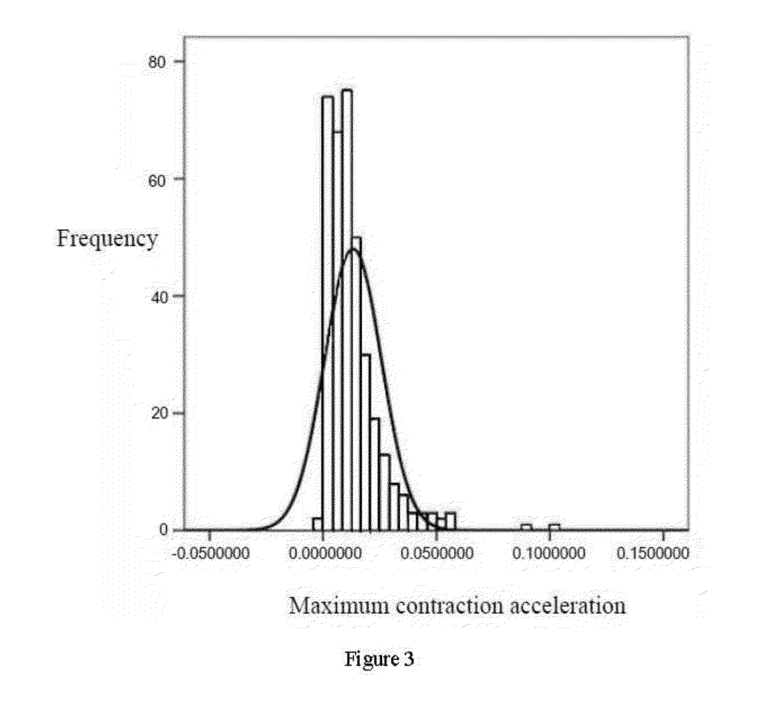

The normal value of absolute value of contraction acceleration a_{d-i} and the normal value of the maximum contraction acceleration a_{d-max} described in the steps above are all taken by statistical method, the maximum contraction acceleration a_{d-max} is taken as an example for detailed description below, FIG. 3 is the histogram of the maximum contraction acceleration and frequency of a male patient having urethral obstruction with detrusor muscle being in normal state, the quantity of sample is 361, the maximum contraction acceleration is −0.0022˜0.104, the arithmetic mean is 0.013160665±0.0124720779, the median is 0.01016 according to the result of statistic data shown in the histogram. During practical application, comparing the testing data with the statistical result mentioned above can be used for checking and analysing.

A method for urodynamics testing and analysing according to the present invention can be described in more details with the embodiment below.

The testing method comprises the following steps for a 60 year old male patient having bladder outlet obstruction:

(1) keeping anterior urethra perpendicular to the direction of gravity (semiprone position for female patient, standing position for male patient);

(2) turning on power, initializing system, attaching abdomen electrode or placing rectum gives (zero adjustment);

(3) pushing start button, the patient start to release urine;

(4) collecting the data of both urine mass and horizontal displacement images by a certain frequency in system, and transferring the data into computer through cache;

(5) pushing end button after ending urine releasing, and marking releasing urine one time;

(6) testing residual urine volume with B-ultrasound, and inputting the data;

(7) calculating and analyzing the data artificially or with computer;

(8) outputting result, diagram and conclusion.

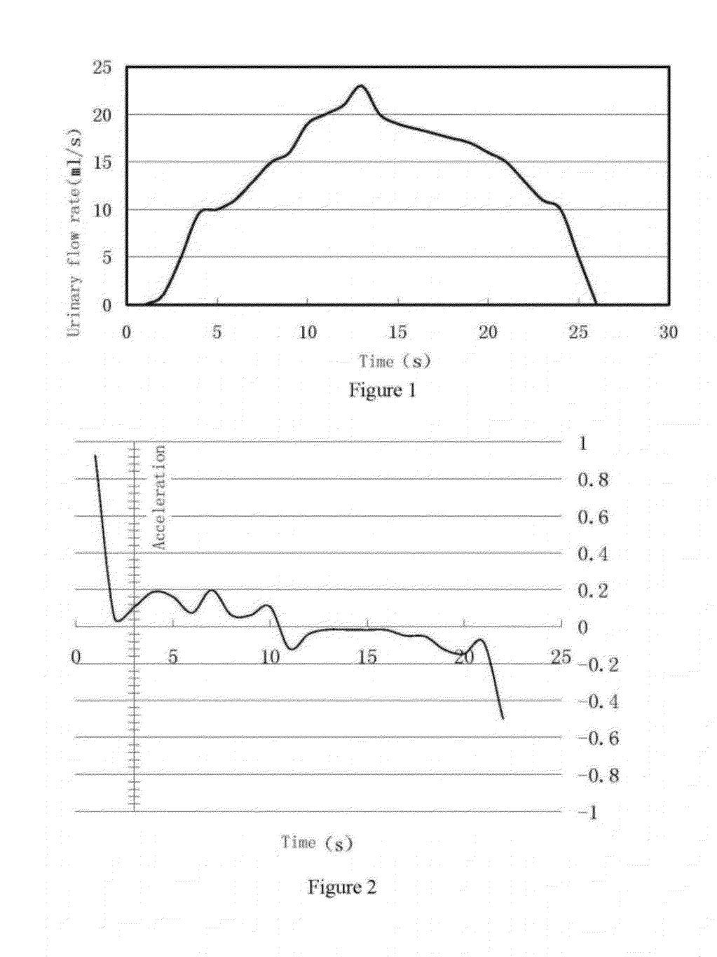

The diagrams according to the testing are shown in FIG. 1,2.

FIG. 1 is the diagram of urinary flow rate showing that the curve is normal, the urine volume is 343 ml and the maximum urinary flow rate exceeds 20 ml/s. As can be seen from the diagram, it is normosthenuria for the patient and the residual urine volume is 1000 ml. The normal urinary flow rate shows that the passive force plays a major role due to excessive dilatation of bladder.

As shown in FIG. 2, the contraction speedup of detrusor muscle is less than 0.2 except the value during the beginning 3 S which matches with the fact of no abdominal pressure fluctuation during urine releasing, and the non-linear acceleration curve reflects that the detrusor muscle action is non-linear. The urine volume of urinary bladder is 1343 ml, the slope of the regression equation of contraction velocity calculated by using regression method is 0.45% which is the maximum contraction acceleration of detrusor muscle, the value is far less than the statistical median of the maximum contraction acceleration, 0.01016, which shows that the patient is in the condition of that the contraction performance of urinary bladder is impaired, and need to get further diagnosis and/or treatment.

The following table shows an accuracy of the clinic testing and analyzing result according to the present invention:

| maximum contraction | detrusor muscle | Normal detrusor | |
|---|---|---|---|
| acceleration testing | weakness | muscle | |
| positive | 9 | 21 | 30 |
| negative | 3 | 363 | 366 |
| | 12 | 384 | |

The quantity of samples is 396, and in contrast to gold standard (Invasive urodynamic analysis), the method for testing and analyzing of the present invention has a high accurate rate with a sensibility Se=9/12=75%, a specificity Sp=363/384=94.53%, an accuracy of testing T=372/396=93.94%.

1. A method for urodynamics testing and analysing, comprising:
Step 1: building an elastic element model of urethral bladder to regard the urine inside of urinary bladder before its releasing as a topological sphere, regarding the action of urinary bladder detrusor muscle and abdominal pressure as the action of the elastic element, the elastic modulus thereof is able to vary with time and space changing, and according to the elastic element model defining L=F(a) which shows the function relation between the length of elastic element L and the urine volume of urinary bladder a, and ΔL=ξ(Q,a) which shows the function relation between contraction length ΔL and urinary flow rate Q, urine volume of urinary bladder a;
Step 2: building a urethral model which regarding urethra as horizontally-placed tube, and the length and cross section area thereof vary quickly over time, varying of momentum and energy of the urine in the urethral model reflects action of urethra on urine;
Step 3: keeping anterior urethra perpendicular to the direction of gravity to measure and recording the urination data comprising an original position of urine releasing, a urine releasing height h, a mass of releasing urine mi over time ti, a horizontal displacement di, and calculating urination parameters comprising a urinary flow rate Q over time ti, a urine flow velocity vu-i, a kinetic energy of releasing urine per unit time Ei and a cross-sectional area Si of the urethral model;
Step 4: calculating a contraction length of the elastic element ΔLi according to ΔL=ξ(Q,a) which shows a function relation between contraction length ΔL and urinary flow rate Q, urine volume of urinary bladder a, and further calculating the contraction velocity and contraction acceleration of the elastic element vi and ad-i so as to assess the contraction performance of detrusor muscle by using the maximum contraction acceleration of the elastic element ad-max;
Step 5: learning the condition of urethral resistance by using the cross section area of the urethral model Si, and finding out the state of urethral obstruction by using the maximum cross section area Smax.

2. The method for urodynamics testing and analysing according to claim 1, which further comprising the steps following step 5:
Step 6: taking the maximum value of kinetic energy of releasing urine output per unit time Eimax to check if any change of abdominal pressure occurred: said maximum value of kinetic energy can be a maximum kinetic energy if no any change occurred; the value that the maximum value of kinetic energy minus the work of abdominal pressure can be a maximum kinetic energy if any change occurred;
Step 7: making diagram of maximum kinetic energy-contraction length according to the maximum kinetic energy and the corresponding contraction length ΔLi, and finding out the rate for myodynamia of detrusor muscle and obstruction.

3. The method for urodynamics testing and analysing according to claim 2, wherein a method for checking if the abdominal pressure has some change comprising:
comparing the absolute value of contraction acceleration ad-i with the normal value and issuing a judgment that the change of abdominal pressure exists if more than two absolute value are bigger than normal value during the period of time other than start time T0 and end time TEND, and which occurs before the maximum urinary flow rate value Qmax out of Qi exists, with removing artificial interference and/or instrument artifact.

4. The method for urodynamics testing and analysing according to claim 1, wherein a function relation between the length L of elastic element and the urine volume of urinary bladder a is L=F(a)=2*(π²*a)^{1/3}≈8.36084644*a^{1/3}.

5. The method for urodynamics testing and analysing according to claim 1, wherein a function relation between contraction length ΔL and urinary flow rate Q, urine volume of urinary bladder a is ΔL=ξ(Q,a)=Q/{[a^{1/3}+(a−Q)^{1/3}]²−a^{1/3}*(a−Q)^{1/3}}.

6. The method for urodynamics testing and analysing according to claim 1, wherein a method for measuring the horizontal displacement di comprising:
I. recording the image data of drop point for releasing urine;
II. comparing each frame image recorded with a previous frame image, and ignoring the frame image if it has a same placement image as that of the previous frame image;
III. recording the timepoint of the frame image if it is different from the previous frame image, and performing a binary imaging for it by using the threshold method of a maximum equation difference, and calculating its drop point after boundary searching;
IV. calculating a horizontal displacement di between the original point and the drop point of urine releasing according to the system marks of the concentric circle which has an original point of micturition as its center point.

7. The method for urodynamics testing and analysing according to claim 1, characterized in that a formula for calculating cross section area of urethral model Si is that Si=Qi/vu-i, wherein Qi is urinary flow rate, and vu-i is urine flow velocity.

8. The method for urodynamics testing and analysing according to claim 1, characterized in that the method for calculating the maximum contraction acceleration of the elastic element ad-max comprising:
making time-contraction velocity diagram to take the time periods from starting releasing urine to achieving the maximum urine flow velocity, the maximum urinary flow rate, and the maximum cross section area of the urethra, and calculating the slope of contraction velocity by using regression analysis method and taking the slope as a maximum contraction acceleration ad-max.

9. The method for urodynamics testing and analysing according to claim 1, characterized in that the method for assessing contraction performance of detrusor muscle comprising:
comparing the maximum contraction acceleration with the normal value of that for a same age group;
issuing a judgment that a contraction performance of detrusor muscle is good if the value of maximum contraction acceleration is within normal range; and
issuing a judgment that a contraction performance of detrusor muscle is possible to be impaired and need to do further inspection if the value is less than normal value.

10. The method for urodynamics testing and analysing according to claim 1, characterized in that the method for finding out the state of urethral obstruction comprising:
I. comparing the maximum cross section area with a normal value of that for a same age group, and issuing a judgment that no urethral obstruction exists if the maximum cross-section area value is within normal range, and calculating the maximum radius of urethra to turn to Step V; and issuing a judgment that a urethral obstruction exists if the value is less than a normal value and turn to Step II;
II. making curve for time-cross section area of the urethra, and issuing a judgment that a detrusor-sphincter dyssynergia or other interference factors exist if the curve has a big wave amplitude;
III. reviewing the curve for time-cross section area of the urethra to see if a horizontal long straight section exists, and issuing a judgment that it is constrictive obstruction if it exists, and issuing a judgment that it is compression obstruction if it does not exist;
IV. calculating a maximum theoretical urethral radius;
V. outputting the calculated result.

11. The method for urodynamics testing and analysing according to claim 8, characterized in that the method for assessing contraction performance of detrusor muscle comprising:
comparing the maximum contraction acceleration with the normal value of that for a same age group;
issuing a judgment that a contraction performance of detrusor muscle is good if the value of maximum contraction acceleration is within normal range; and
issuing a judgment that a contraction performance of detrusor muscle is possible to be impaired and need to do further inspection if the value is less than normal value.

12. The method for urodynamics testing and analysing according to claim 7, characterized in that the method for finding out the state of urethral obstruction comprising:
I. comparing the maximum cross section area with a normal value of that for a same age group, and issuing a judgment that no urethral obstruction exists if the maximum cross-section area value is within normal range, and calculating the maximum radius of urethra to turn to Step V; and issuing a judgment that a urethral obstruction exists if the value is less than a normal value and turn to Step II;
II. making curve for time-cross section area of the urethra, and issuing a judgment that a detrusor-sphincter dyssynergia or other interference factors exist if the curve has a big wave amplitude;
III. reviewing the curve for time-cross section area of the urethra to see if a horizontal long straight section exists, and issuing a judgment that it is constrictive obstruction if it exists, and issuing a judgment that it is compression obstruction if it does not exist;
IV. calculating a maximum theoretical urethral radius;
V. outputting the calculated result.
